(19) United States
(12) Patent Application Publication
(10) Pub. No.: US 2010/0077446 A1
(43) Pub. Date: Mar. 25, 2010

(54) CENTER APPARATUS, TERMINAL APPARATUS, AND AUTHENTICATION SYSTEM

(75) Inventors: Katsuyuki UMEZAWA, Machida (JP); Masamori Kashiyama, Isehara (JP); Hirokazu Aoshima, Machida (JP)

Correspondence Address: FOLEY AND LARDNER LLP;SUITE 500, 3000 K STREET NW, WASHINGTON, DC, 20007, US

(73) Assignee: HITACHI AUTOMOTIVE SYSTEMS, LTD.

(21) Appl. No.: 12/497,137

(22) Filed: Jul. 2, 2009

(30) Foreign Application Priority Data
Sep. 19, 2008 (JP) 2008-240196

(51) Int. Cl. H04L 9/32

(52) U.S. Cl. 726/2; 713/168

(57) ABSTRACT

The present invention provides a system and a method, in which after authenticating a device, the user authentication methods are switched and used. Specifically, in performing user authentication via a terminal apparatus, the terminal apparatus is authenticated first and then based on this authentication result, a practical use of the terminal apparatus is determined, and the user authentication methods are switched so as to suit this practical use and the resultant method is implemented.

### INCORPORATION BY REFERENCE

The present application claims priority from Japanese application JP2008-240196 filed on Sep. 19, 2008, and the content of which is hereby incorporated by reference into this application.

### BACKGROUND

The present invention relates to a system for performing user authentication and providing services to a valid user.

An authentication method based on a three entities model of a user, a personal terminal apparatus, and a server is known (for example, FIG. 6, Paragraphs 0057-0068, in JP-A-2003-44436, hereinafter referred to as Document 1). Moreover, a method having a plurality of authentication unit, whereby the authentication is performed stepwise or by using a combination of the plurality of authentication unit is known (for example, FIG. 8, Paragraphs 0071-0077 in JP-A-2002-269043, hereinafter referred to as Document 2). Furthermore, a method is known, in which the terminal apparatus authentications are switched according to the performance of a terminal apparatus (for example, FIG. 20, Paragraphs 0073-0077 in JP-A-2007-305140, hereinafter referred to as Document 3).

### SUMMARY

As the usage of vehicles in recent years, a lease or rental use or a shared use by car sharing has been increasing. In receiving telematics services for vehicles, if a vehicle is an individual's property, then the authentication of an on-board device (car navigation terminal) which is an individual's property is sufficient. However, the authentication of an on-board device is predicted to be insufficient in the future due to the change in the usage of vehicles described above. In other words, the authentication of an individual who is driving a vehicle at that time point is predicted to be important.

In authenticating an individual, in the case of a private vehicle, personal information can be registered in a car navigation terminal so as to be used in the authentication, however, in the case of a rental car or car sharing, personal information cannot be registered in a car navigation terminal of a vehicle to share and thus an alternative method needs to be used. In other words, the user authentication methods may need to be switched according to the usage of a vehicle.

In the Document 1, although an authentication method based on three parties of a user, a personal terminal apparatus, and a server has been disclosed, the user authentication methods cannot be switched according to the usage of a personal terminal apparatus. Moreover, in the Document 2, although a method of authenticating a user stepwise using a combination of a plurality of user authentications has been disclosed, the user authentication methods cannot be switched according to the usage of a terminal apparatus. Furthermore, in the Document 3, although a method of switching terminal apparatus authentications according to the performance of a terminal apparatus has been disclosed, the user authentications via the terminal apparatus cannot be switched.

The present invention has been made in light of the above-described circumstances, and provides a system, in which after authenticating a device, the user authentication methods are switched and used.

Specifically, in performing user authentication via a terminal apparatus, the terminal apparatus is authenticated first and then based on this authentication result, a practical use of the terminal apparatus is determined, and the user authentication methods are switched so as to suit this practical use and the resultant method is implemented.

That is, in a terminal apparatus and a user authentication system provided by the disclosed system, the terminal apparatus makes an access request to a center apparatus and sends access request information. Upon receipt of the access request information, the center apparatus makes a terminal apparatus authentication request to the terminal apparatus and sends server authentication information. The terminal apparatus authenticates the server by using the server authentication information, and as a result, if the server is validated, the terminal apparatus sends terminal apparatus authentication information. Upon receipt of the terminal apparatus authentication information, a terminal apparatus practical-use determining unit of the center apparatus determines that the terminal apparatus is a valid terminal apparatus from terminal apparatus information registered in a terminal apparatus information DB (DataBase) and the terminal apparatus authentication information received from the terminal apparatus. Thereafter, an authentication method determining unit determines a user authentication method from the terminal apparatus determination result and a decision rule of a user authentication method registered in an authentication policy DB. If digest authentication using a user device is determined, the center apparatus sends a digest authentication request to the terminal apparatus. The terminal apparatus sends the digest authentication request to the user device. An encryption operation unit of the user device performs an encryption operation by using the received digest authentication request information and secret information that is stored in advance in a key storage unit, and sends digest authentication information as the result to the terminal apparatus. The terminal apparatus transfers this digest authentication information to the center apparatus. An authentication processing unit of the center apparatus performs user authentication by using the received digest authentication information and the user information registered in a user information DB, and if it is confirmed that the user is a valid user, a service providing unit provides a service to the terminal apparatus.

Moreover, if the user authentication method determining unit of the center apparatus determines authentication using an ID (identification) and a password, the center apparatus sends an ID and password authentication request to the terminal apparatus. The terminal apparatus acquires a user ID and a password registered in a user information unit. At this time, instead of acquiring the ID and password registered in the user information unit of the terminal apparatus, the terminal apparatus may acquire an ID and a password registered in the user device via a data transmission/reception unit.

The terminal apparatus sends the acquired ID and password to the center apparatus. The authentication processing unit of the center apparatus performs user authentication by using the received ID and password and the user information registered in the user information DB, and if the user is validated, the service providing unit provides a service to the terminal apparatus.

According to a more specific example, there is provided an authentication system wherein a center apparatus authenticates a user using a terminal apparatus in order to provide a service, wherein the terminal apparatus includes: a terminal apparatus information unit for storing terminal apparatus information of the terminal apparatus; and a service enjoying unit for enjoying a service provided by the center apparatus, wherein the center apparatus includes: a terminal apparatus information DB for storing a practical use for each terminal apparatus; an authentication policy DB having a plurality of combinations of practical uses and authentication methods of the terminal apparatus registered therein as an authentication policy; an authentication method determining unit which determines a user authentication method from the authentication policy registered in the authentication policy DB; an authentication processing unit which performs authentication processing according to a user authentication method determined by the authentication method determining unit; and a service providing unit which provides a service to the terminal apparatus if the authentication processing is successful.

Furthermore, the center apparatus includes a terminal apparatus practical-use determining unit which determines a practical use of the terminal apparatus from the terminal apparatus information received from the terminal apparatus and the terminal apparatus information DB, wherein the authentication method determining unit of the center apparatus may determine a user authentication method based on a practical use of the terminal apparatus determined by the terminal apparatus practical-use determining unit and the authentication policy registered in the authentication policy DB.

Furthermore, the terminal apparatus may include an authentication processing unit for performing authentication processing according to an authentication request of the center apparatus, and the center apparatus may include a user information DB for storing information associated with a user ID, wherein when a user authentication method determined by the authentication method determining unit requests the terminal apparatus to generate authentication information, the center apparatus may send an authentication request including a random number to the terminal apparatus, and the authentication processing unit of the terminal apparatus may generate authentication information based on the random number, and the terminal apparatus may send to the center apparatus this authentication information along with user information which the user information unit of the terminal apparatus stores, and the authentication processing unit of the center apparatus may perform the user authentication processing based on the authentication information and user information received from the terminal apparatus and the sent random number and the information stored in the user information DB.

Furthermore, the terminal apparatus may include a user device and a data transmission/reception unit for transmitting/receiving data, wherein the user device may include: a data transmission/reception unit for transmitting/receiving data to/from the terminal apparatus; a key storage unit for storing secret information; and an encryption operation unit for performing encryption/decryption by using the secret information, wherein an authentication processing unit of the center apparatus may send an authentication request to the terminal apparatus based on the determined authentication method, wherein an authentication processing unit of the terminal apparatus may send the authentication request to the user device according to the authentication request, wherein the encryption operation unit of the user device may send a processing result of the encryption/decryption based on the authentication request to the terminal apparatus, wherein the authentication processing unit of the terminal apparatus may send a processing result of the encryption/decryption to the center apparatus, and wherein the authentication processing unit of the center apparatus may perform a processing based on a processing result of the encryption/decryption in the determined authentication method.

Furthermore, the authentication processing unit of the center apparatus may make a terminal apparatus authentication request based on an access request from the terminal apparatus, and may send server authentication information in making the terminal apparatus authentication request, wherein an authentication processing unit of the terminal apparatus may authenticate the center apparatus by using the server authentication information, and wherein if the authentication processing unit of the terminal apparatus can authenticate the center apparatus, then the terminal apparatus may send the terminal apparatus information to the center apparatus, and the authentication processing unit of the center apparatus may authenticate the terminal apparatus based on the terminal apparatus information.

Note that, a user authentication method to request may be an ID password method, a digest authentication method, or an authentication method based on a public key infrastructure (PKI).

Moreover, the above-described center apparatus includes: a communication unit for transmitting/receiving data; a terminal apparatus information DB for storing a practical use for each terminal apparatus; an authentication policy DB having a plurality of combinations of practical uses and authentication methods of the terminal apparatus registered therein as an authentication policy; an authentication method determining unit which determines a user authentication method from the authentication policy registered in the authentication policy DB; an authentication processing unit which performs authentication processing according to a user authentication method determined by the authentication method determining unit; and a service providing unit which provides a service to the terminal apparatus if the authentication processing is successful.

Furthermore, the center apparatus may include a terminal apparatus practical-use determining unit which determines a practical use of a terminal apparatus from the terminal apparatus information received from the terminal apparatus and the terminal apparatus information DB, wherein the authentication method determining unit may determine a user authentication method based on a practical use of the terminal apparatus determined by the terminal apparatus practical-use determining unit and the authentication policy registered in the authentication policy DB.

Moreover, the above-described terminal apparatus includes: a communication unit for transmitting/receiving data to/from the center apparatus; a data transmission/reception unit for transmitting/receiving data to/from a user device; a terminal apparatus information unit for storing terminal apparatus information of the terminal apparatus; an authentication processing unit which performs authentication processing according to an authentication request of the center apparatus; and a service enjoying unit which enjoys a service provided by the center apparatus if the terminal apparatus is authenticated by the center apparatus through the authentication processing.

Furthermore, the terminal apparatus may include a user information unit for storing user information of one or more users, wherein the authentication processing unit may acquire the user information from the user information unit according to an authentication request of the center apparatus, and the communication unit may send the user information to the center apparatus.

Furthermore, in the terminal apparatus, the authentication processing unit may acquire the terminal apparatus information from the terminal apparatus information unit according to an authentication request of the center apparatus, and the communication unit may send the terminal apparatus information to the center apparatus.

According to the teaching herein, when a center apparatus authenticates a terminal apparatus and a user, user authentication methods are switched according to the usage of the terminal apparatus, thereby making it possible to perform more appropriate authentication processing.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 shows an example of a configuration diagram of a terminal apparatus and user authentication system according to an embodiment of the present invention.

FIG. 2 shows an example of a hardware configuration of a terminal apparatus according to this embodiment.

FIG. 3 shows an example of a hardware configuration of a user device according to this embodiment.

FIG. 4 shows an example of a process flow in performing authentication processing according to this embodiment.

FIG. 5 shows an example of a configuration of a terminal apparatus information DB according to this embodiment.

FIG. 6 shows an example of a configuration of an authentication policy DB of an embodiment of the present invention.

FIG. 7 shows an example of a configuration of a user information DB according to this embodiment.

### DESCRIPTION OF THE EMBODIMENTS

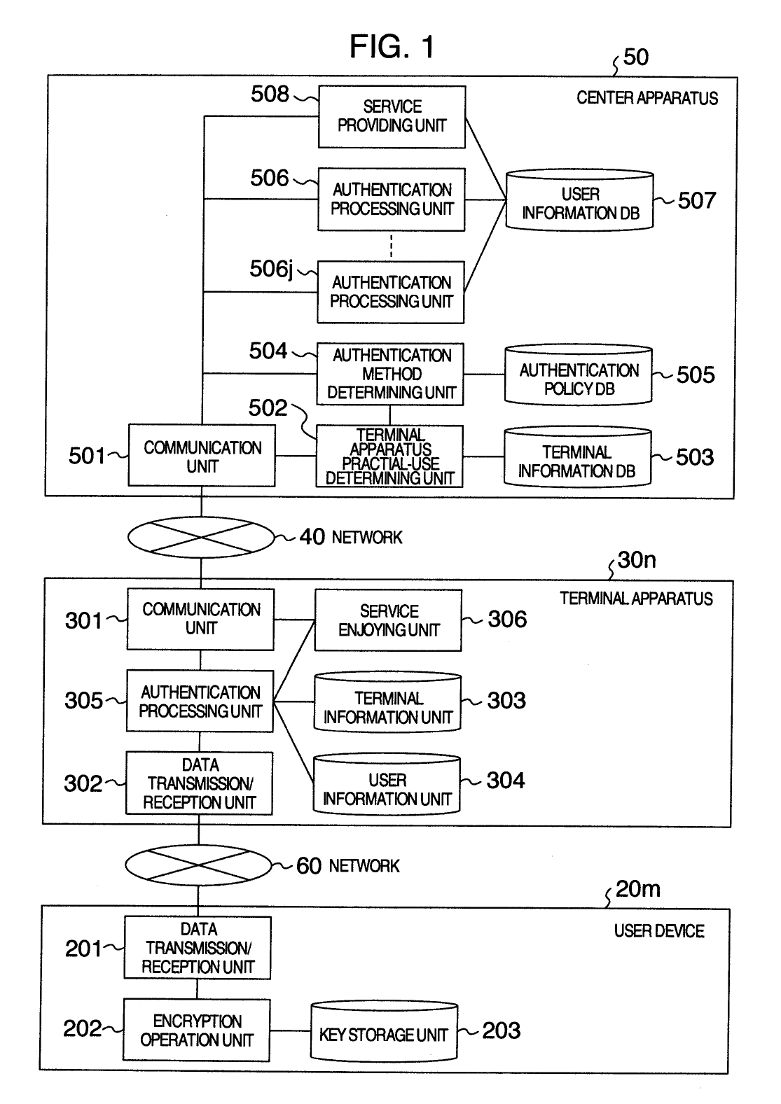

FIG. 1 is a functional configuration diagram of a terminal apparatus and a user authentication system according to an embodiment of the present invention. In the terminal apparatus and the user authentication system of this embodiment, as shown in FIG. 1, n terminal apparatuses 30n (n is an integer equal to or greater than 1 and n may be omitted.) and a center apparatus 50 are coupled with each other via one or more networks 40, such as the Internet and a portable telephone network. Furthermore, m user devices 20m (m is an integer equal to or greater than 1 and m may be omitted.) are coupled with one terminal apparatus 30n via one or more networks 60 such as an in-car wired network and a non-contact wireless communication network.

The center apparatus 50 authenticates the terminal apparatus 30n via the network 40, and based on this authentication result, the center apparatus 50 determines a user authentication method and notifies the terminal apparatus 30n of the determined user authentication method.

The terminal apparatus 30n performs a user authentication processing based on the notified authentication method. If this specified user authentication processing is a method using a user device, the terminal apparatus 30n requests the user device 20m for user authentication information via the network 60. The terminal apparatus 30n notifies the center apparatus 50 of the user authentication information acquired from the user device 20m, via the network 40. The center apparatus 50 performs authentication based on the user authentication information sent from the terminal apparatus 30n, and if the authentication passes (the authentication is successful), the center apparatus 50 provides a service to the terminal apparatus 30n via the network 40. If the authentication fails, then the center apparatus 50 sends an authentication failure notification to the terminal apparatus 30n via the network 40.

The user device 20m includes: a data transmission/reception unit 201 for transmitting/receiving data to/from the terminal apparatus 30n; a key storage unit 203 for storing secret information such as a key and a password, and an encryption operation unit 202 for performing encryption by using the secret information.

The terminal apparatus 30n includes: a communication unit 301 for transmitting/receiving data to/from the center apparatus 50 via the network 40 or 60; a data transmission/reception unit 302 for transmitting/receiving data to/from the user device 20m via the network 60; a terminal apparatus information unit 303 for storing terminal apparatus information of the terminal apparatus 30n; a user information unit 304 for storing user information of one or more users; an authentication processing unit 305 which performs authentication processing according to an authentication request of the center apparatus 50; and a service enjoying unit 306 for enjoying a service provided by the center apparatus 50. An example of the terminal apparatus information in which the terminal apparatus information unit 303 stores includes a terminal apparatus ID.

The center apparatus 50 includes: a communication unit 501 for transmitting/receiving data via the network 40; a terminal apparatus information DB 503 for storing terminal apparatus information; a terminal apparatus practical-use determining unit 502 which determines a practical use of the terminal apparatus 30n from the terminal apparatus information received from the terminal apparatus 30n and the terminal apparatus information stored in the terminal apparatus information DB 503; an authentication policy DB 505 having a plurality of combinations of practical uses and authentication methods of the terminal apparatus registered therein as an authentication policy; an authentication method determining unit 504 which determines a user authentication method from the determination result of the terminal apparatus practical-use determining unit 502 and the authentication policy registered in the authentication policy DB; a plurality of authentication processing units 506j (j is an integer equal to or greater than 1 and j may be omitted.) which perform an authentication processing based on the determination of the authentication method determining unit 504; a user information DB 507 for managing user information; and a service providing unit 508 for providing a service.

Note that, if the authentication method determined based on the determination of the authentication method determining unit 504 of the center apparatus 50 is a method which does not use the user device 20m, then the user device 20m and the data transmission/reception unit 302 of the terminal apparatus 30n are not used. Moreover, if a method using the user device 20m is determined, the user information unit 304 of the terminal apparatus 30n is not used.

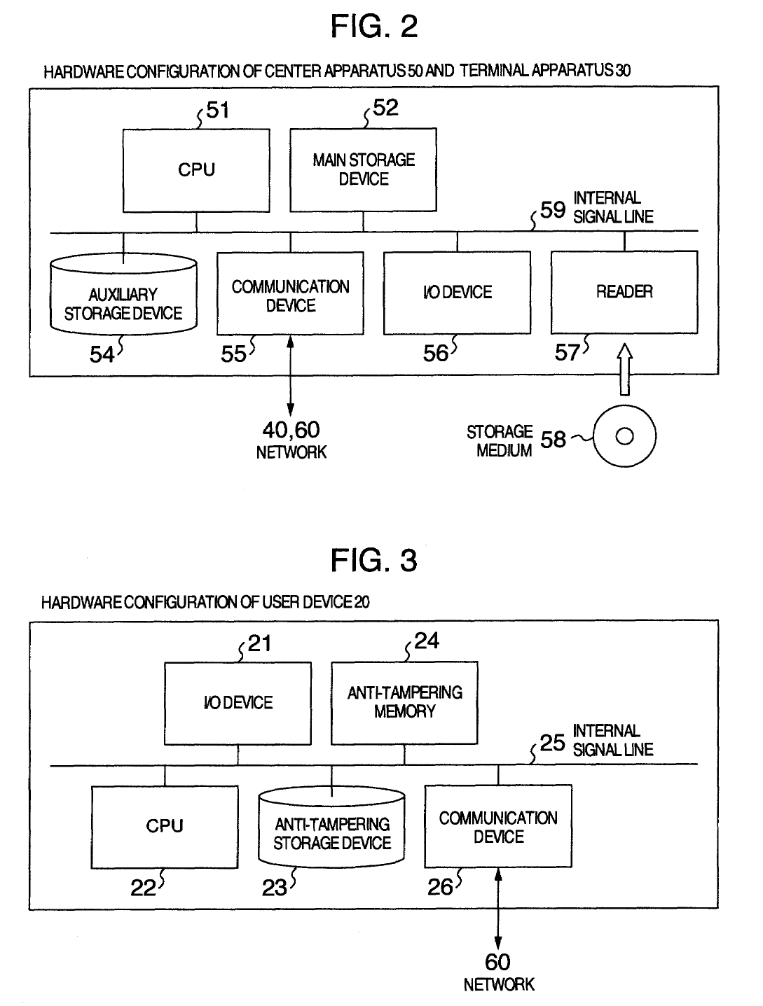

FIG. 2 is a hardware configuration diagram of the center apparatus 50. In the center apparatus 50, a CPU 51, a main storage device 52, an auxiliary storage device 54, a communication device 55, an input/output (I/O) device 56, a reader 57 of a storage medium 58, and the like are coupled with each other via an internal communication line 59 such as a bus.

The terminal apparatus 30n also has a hardware configuration (the illustration is omitted) similar to that of the center apparatus 50, although there is a difference in the size or performance thereof.

FIG. 3 is a hardware configuration diagram of the user device 20m. In the user device 20m, a CPU 22, an I/O device 21, an anti-tampering memory 24, an anti-tampering storage device 23, a communication device 26, and the like are coupled with each other via an internal communication line 25 such as a bus.

Each processing of this embodiment described below is implemented by loading a processing program stored in the auxiliary storage device 54 of each apparatus into the main memory unit 52 and executing the same by the CPU 51. Moreover, each program may be stored in the auxiliary storage device 54 in advance, or may be loaded via the other storage medium or a communication medium (the network 40 or a carrier or digital signal propagating over the network 40) when required.

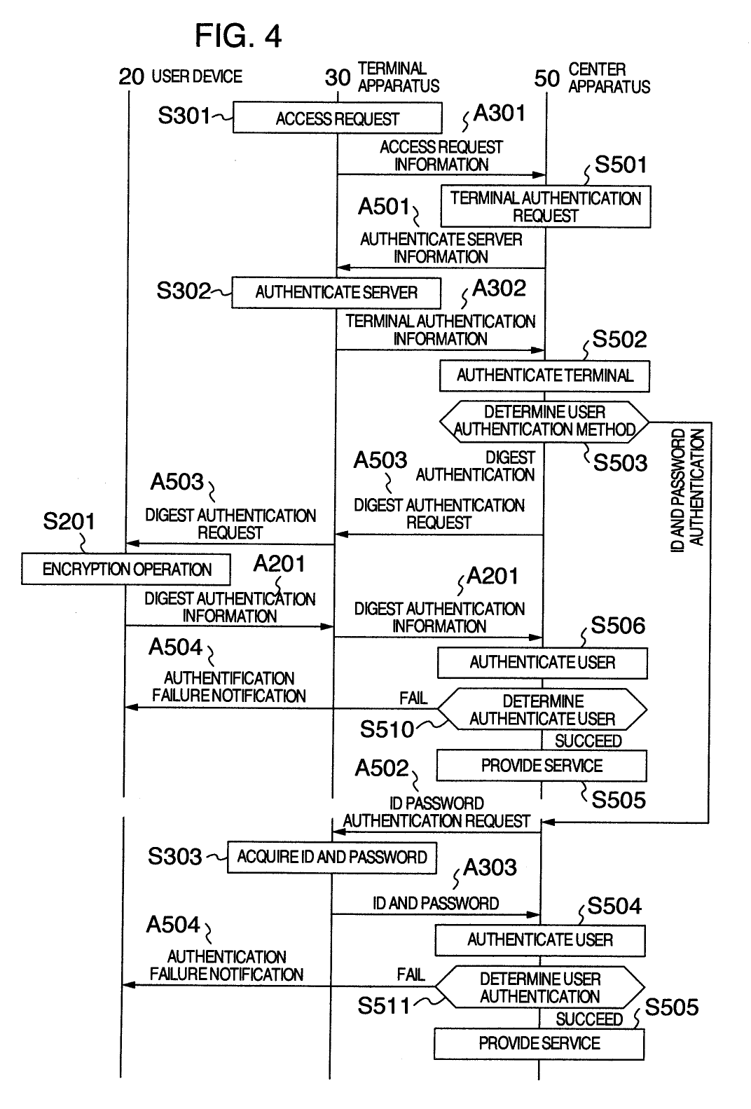

FIG. 4 is a process flow chart when the center apparatus 50 performs a terminal apparatus authentication processing and consequently performs the authentication processing using the user device 20m.

First, the service enjoying unit 306 of the terminal apparatus 30n makes an access request to the center apparatus 50 (S301), and sends access request information A301. Upon receipt of the access request information A301, the service providing unit 508 of the center apparatus 50 makes a terminal apparatus authentication request by sending server authentication information A501 to the terminal apparatus 30n (S501).

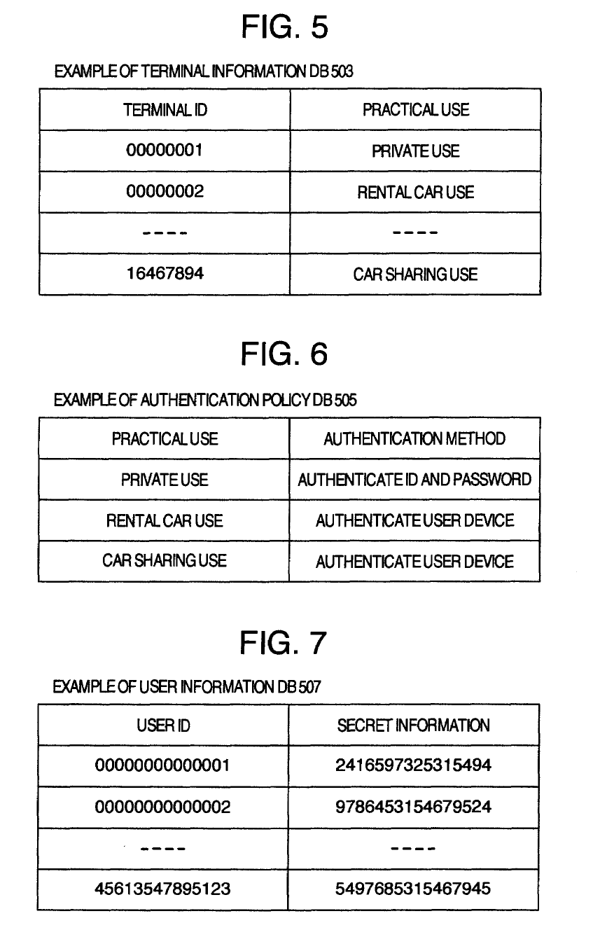

The authentication processing unit 305 of the terminal apparatus 30n authenticates a server by using the server authentication information A501 (S302), and as a result of the server authentication, if the server is validated, the authentication processing unit 305 of the terminal apparatus 30n sends terminal apparatus authentication information A302. The terminal apparatus authentication information A302 includes at least a terminal apparatus ID or the information obtained by encrypting the terminal apparatus ID with a secret key or the like of the server. Upon receipt of the terminal apparatus authentication information A302, the terminal apparatus practical-use determining unit 502 of the center apparatus 50 authenticates whether the terminal apparatus is a valid one, from the terminal apparatus information registered in the terminal apparatus information DB 503 and the terminal apparatus authentication information A302 received from the terminal apparatus 30n (S502). If the terminal apparatus is validated, the authentication method determining unit 504 determines a practical use of the terminal apparatus from the terminal apparatus ID included in the terminal apparatus authentication information A302 and the terminal apparatus information DB 503 shown in FIG. 5, and then the authentication method determining unit 504 determines a user authentication method from this practical use and a decision rule of the user authentication method (authentication policy) registered in the authentication policy DB 505 (S503). The subsequent processes will be split according to this decision result of the user authentication method. First, a case in which digest authentication using the user device 20m is determined is described below.

The authentication method determining unit 504 of the center apparatus 50 sends a digest authentication request A503 to the terminal apparatus 30n. The terminal apparatus 30n sends the received digest authentication request A503 to the user device 20m. The encryption operation unit 202 of the user device 20m performs an encryption operation by using the information included in the received digest authentication request A503 and the secret information (specifically, secret information associated with the user ID) that is stored in the key storage unit 203 in advance (S201). For example, the authentication method determining unit 504 of the center apparatus 50 sends the digest authentication information A503 including a random number, and the encryption operation unit 202 performs an encryption operation on a random number included in the digest authentication information A503, with secret information of a user as a key.

The encryption operation unit 202 sends digest authentication information A201 as a result of the operation to the terminal apparatus 30n. The terminal apparatus 30n transfers this digest authentication information A201 to the center apparatus 50. The authentication processing unit 506j of the center apparatus 50 performs user authentication by using the received digest authentication information A201 and the user information (specifically, secret information associated with the user ID) registered in the user information DB 507 (S506). Specifically, for example, the authentication processing unit 506j of the center apparatus 50 checks if the same result of the encryption operation can be obtained, by using the same random number as the one sent to the terminal apparatus 30n and the secret information associated with the user ID.

If the user is validated, the service providing unit 508 provides a service to the terminal apparatus 30n, and the service enjoying unit 306 of the terminal apparatus 30n enjoys the service (S505). If it is determined that the user is not a valid user (S510), then the service provision by the service providing unit 508 is not performed, and the authentication processing unit 506j of the center apparatus 50 sends an authentication failure notification (A504), which is then displayed on the terminal apparatus 30n.

Next, a case in which an ID password authenticating method is determined by the user authentication method determining process (S503) is described below.

The center apparatus 50 sends an ID password authentication request A502 to the terminal apparatus 30n. The authentication processing unit 305 of the terminal apparatus 30n acquires the user ID and password registered in the user information unit 304 (S303). At this time, instead of acquiring the ID and password registered in the user information unit of the terminal apparatus 30n, the authentication processing unit 305 of the terminal apparatus 30n may acquire the ID and password registered in the user device 20m via the data transmission/reception unit 302. Moreover, the ID and password may be input by a user using the I/O device 56 of the terminal apparatus 30n.

The communication unit 301 of the terminal apparatus 30n sends the ID and password A303 acquired by the authentication processing unit 305 to the center apparatus 50. The authentication processing unit 506j of the center apparatus 50 performs user authentication by using the received ID and password A203 and the user information registered in the user information DB 507 (S504).

If the user is validated, the service providing unit 508 provides a service to the terminal apparatus, and the service enjoying unit 306 of the terminal apparatus 30n enjoys the service (S505). If it is determined that the user is not a valid user (S511), then the service provision by the service providing unit 508 is not performed, and the authentication processing unit 506j of the center apparatus 50 sends an authentication failure notification (A504), which is then displayed on the terminal apparatus 30n.

FIG. 5 shows an example of the terminal apparatus information registered in the terminal apparatus information DB 503 of the center apparatus 50. The terminal apparatus ID is associated with its practical use and registered. By including the terminal apparatus ID in the terminal apparatus authentication information A302 sent from the terminal apparatus 30n to the center apparatus 50 in FIG. 4, the center apparatus 50 can identify the practical use of the terminal apparatus 30n from the terminal apparatus information DB 503 shown in FIG. 5. Additionally, the information on the practical use of the terminal apparatus may be included in the terminal apparatus authentication information A302. In this case, the terminal apparatus information DB of the center apparatus 50 does not require the information on the practical use.

FIG. 6 shows an example of the authentication policy registered in the authentication policy DB 505 of the center apparatus 50. A practical use of the terminal apparatus is associated with an authentication method and registered. In the user authentication method determining process (S503) of the center apparatus 50 in FIG. 4, by referring to the authentication policy DB 505, a user authentication method which is requested to the terminal apparatus 30n can be determined. Additionally, in this embodiment, as the practical use, how to utilize a vehicle is described as an example, however, the type of information doesn't matter if it is the information for determining the authentication method. Moreover, as the authentication method, two types of methods are embodied here, however, three or more types of methods may be embodied.

FIG. 7 shows an example of the user information registered in the user information DB 507 of the center apparatus 50, where a user ID and an authentication method are associated with each other and registered. The secret information is information to which the authentication processing unit 506 of the center apparatus refers in the user authentication processing (S504 and S506) of the center apparatus 50 in FIG. 4. In this embodied, the secret information is used as a password for an ID password authenticating method or a secret key for the digest authentication method. Since necessary secret information differs according to the difference in the user authentication processing which the center apparatus 50 performs, the user information DB 507 may include information other than the information shown in FIG. 7. For example, in the case of the user authentication method based on the public key encryption method, the user information DB 507 may include a public key certificate of a user as the user information. Moreover, necessary secret information which is not stored in the user information DB 507 may be acquired from the terminal apparatus 30n at every user authentication.

In FIG. 4, the terminal apparatus 30n performs the server authentication processing (S302), however, the server authentication may be omitted by setting a restriction that the terminal apparatus 30n accesses only a specific center apparatus 50.

Moreover, the transmission/reception of data may be performed by encrypting communications between the center apparatus 50 and the terminal apparatus 30n, between the terminal apparatus 30n and the user device 20m, and between the center apparatus 50 and the user device 20m.

Moreover, the user authentication method determined by the center apparatus 50 is not limited to the ID password authentication and the digest authentication, and any user authentication may be performed.

The specification and drawings are, accordingly, to be regarded in an illustrative rather than a restrictive sense. It will, however, be evident that various modifications and changes may be made thereto without departing from the spirit and scope of the invention as set forth in the claims.

1. A center apparatus for providing a service to a terminal apparatus, comprising:
a communication unit which transmits/receives data;
a terminal apparatus information DB which stores a practical use for each terminal apparatus;
an authentication policy DB having a plurality of combinations of practical uses and authentication methods of the terminal apparatus registered therein as an authentication policy;
an authentication method determining unit which determines a user authentication method from the authentication policy registered in the authentication policy DB;
an authentication processing unit which performs authentication processing according to a user authentication method determined by the authentication method determining unit; and
a service providing unit which provides a service to the terminal apparatus if the authentication processing is successful.

2. The center apparatus according to claim 1, further comprising a terminal apparatus practical-use determining unit which determines a practical use of the terminal apparatus from terminal apparatus information received from the terminal apparatus and the terminal apparatus information DB, wherein the authentication method determining unit determines a user authentication method based on a practical use of the terminal apparatus determined by the terminal apparatus practical-use determining unit and the authentication policy registered in the authentication policy DB.

3. A terminal apparatus which enjoys a service provided by a center apparatus, the terminal apparatus comprising:
a communication unit which transmits/receives data to/from the center apparatus;
a data transmission/reception unit which transmits/receives data to/from a user device;
a terminal apparatus information unit which stores terminal apparatus information of the terminal apparatus;
an authentication processing unit which performs authentication processing according to an authentication request of the center apparatus; and
a service enjoying unit which enjoys a service provided by the center apparatus if the terminal apparatus is authenticated by the center apparatus through the authentication processing.

4. The terminal apparatus according to claim 3, further comprising a user information unit which stores user information of one or more users, wherein the authentication processing unit acquires the user information from the user information unit according to an authentication request of the center apparatus, and wherein
the communication unit sends the user information to the center apparatus.

5. The terminal apparatus according to claim 3, wherein
the authentication processing unit acquires the terminal apparatus information from the terminal apparatus information unit according to an authentication request of the center apparatus, and wherein
the communication unit sends the terminal apparatus information to the center apparatus.

6. An authentication system wherein a center apparatus authenticates a user using a terminal apparatus in order to provide a service, wherein the terminal apparatus comprises:
a terminal apparatus information unit which stores terminal apparatus information of the terminal apparatus; and
a service enjoying unit which enjoys a service provided by the center apparatus, wherein
the center apparatus comprises:
a terminal apparatus information DB which stores a practical use for each terminal apparatus;
an authentication policy DB having a plurality of combinations of practical uses and authentication methods of the terminal apparatus registered therein as an authentication policy;
an authentication method determining unit which determines a user authentication method from the authentication policy registered in the authentication policy DB;
an authentication processing unit which performs authentication processing according to a user authentication method determined by the authentication method determining unit; and
a service providing unit which provides a service to the terminal apparatus if the authentication processing is successful.

7. The authentication system according to claim 6, wherein
the center apparatus includes a terminal apparatus practical-use determining unit which determines a practical use of the terminal apparatus from terminal apparatus information received from the terminal apparatus and the terminal apparatus information DB, wherein
the authentication method determining unit of the center apparatus determines a user authentication method based on a practical use of the terminal apparatus determined by the terminal apparatus practical-use determining unit and the authentication policy registered in the authentication policy DB.

8. The authentication system according to claim 7, wherein
the terminal apparatus includes an authentication processing unit which performs authentication processing according to an authentication request of the center apparatus, wherein
the center apparatus includes a user information DB which stores information associated with a user ID, wherein
when a user authentication method determined by the authentication method determining unit requests the terminal apparatus to generate authentication information,
the center apparatus sends an authentication request including a random number to the terminal apparatus, and
the authentication processing unit of the terminal apparatus generates authentication information based on the random number,
the terminal apparatus sends to the center apparatus this authentication information along with user information which a user information unit of the terminal apparatus stores, and
the authentication processing unit of the center apparatus performs the user authentication processing based on the authentication information and the user information received from the terminal apparatus and the sent random number and the information stored in the user information DB.

9. The authentication system according to claim 6, wherein
the terminal apparatus includes a user device and a data transmission/reception unit which transmits/receives data, wherein the user device includes:
a data transmission/reception unit which transmits/receives data to/from the terminal apparatus;
a key storage unit which stores secret information; and
an encryption operation unit which performs encryption/decryption by using the secret information, wherein
the authentication processing unit of the center apparatus sends an authentication request to the terminal apparatus based on the determined authentication method, wherein
an authentication processing unit of the terminal apparatus sends the authentication request to the user device according to the authentication request, wherein
the encryption operation unit of the user device sends a processing result of the encryption/decryption based on the authentication request to the terminal apparatus, wherein
the authentication processing unit of the terminal apparatus sends a processing result of the encryption/decryption to the center apparatus, and wherein
the authentication processing unit of the center apparatus performs processing based on a processing result of the encryption/decryption in the determined authentication method.

10. The authentication system according to claim 6, wherein
the authentication processing unit of the center apparatus makes a terminal apparatus authentication request based on an access request from the terminal apparatus, and sends server authentication information in making the terminal apparatus authentication request, wherein
an authentication processing unit of the terminal apparatus authenticates the center apparatus by using the server authentication information, and
when the center apparatus is successfully authenticated, the terminal apparatus sends the terminal apparatus information to the center apparatus, and the authentication processing unit of the center apparatus authenticates the terminal apparatus based on the terminal apparatus information.

11. The authentication system according to claim 6, wherein a user authentication method to request is an ID password method, a digest authentication method, or a public key authentication method.
